(19) United States
(12) Patent Application Publication
(10) Pub. No.: US 2002/0069084 A1
(43) Pub. Date: Jun. 6, 2002

(54) Method and system for countering terrorism and monitoring visitors from abroad

(76) Inventor: John K. Donovan, Alexandria, VA (US)

Correspondence Address: Samuel C. Miller, III, BURNS, DOANE, SWECKER & MATHIS, L.L.P., P.O. Box 1404, Alexandria, VA, 22313-1404, US

(21) Appl. No.: 10/055,998

(22) Filed: Jan. 28, 2002

Related U.S. Application Data
(63) Continuation-in-part of application No. 09/476,817, filed on Jan. 3, 2000.

(51) Int. Cl. G06F 17/60

(52) U.S. Cl. 705/1

(57) ABSTRACT

Methods and systems are disclosed for monitoring foreign visitors, detecting visa overstays and collecting intelligence, particularly useful in countering international terrorism. The methods and systems employ internet, self-reporting techniques and automated data processing.

### RELATED APPLICATIONS

This application is a Continuation-in-Part application of U.S. application Ser. No. 09/476,817 to John K. Donovan filed Jan. 3, 2000, which application is hereby incorporated by reference herein in its entirety.

### FIELD OF INVENTION

The present invention relates to methods and systems for monitoring designated individuals such as foreign visitors, and, in preferred embodiments, methods and systems for countering terrorism by monitoring non-immigrant visa holders (users) using internet reporting and contacting.

### BACKGROUND OF THE INVENTION

Millions of foreign nationals visit the United States each year under one of several visitor visa programs. Due to lack of compliance enforcement, many foreign visitors overstay the departure date required by their visas and remain in the country illegally or otherwise violate the terms of their visitors visas. It has been recognized that the inability to track foreign visitors is a significant threat to our national security. In addition, although most foreign visitors are a boon to commerce and the U.S. economy, there are those who engage in activities harmful to the U.S., including international terrorism, importation of illegal drugs, international organized crime and economic espionage. The combined economic losses to our economy from these activities total in the hundreds of billions of dollars.

In 1998, a review of the existing INS procedures by the General Accounting Office (GAO) revealed that there is currently no method to determine if or when a foreign visitor has left the U.S. at the termination of his visa. GAO/NSIAD-98-69, Report to the Honorable Bob Graham and the Honorable Ernest F. Hollings, U.S. Senate, March 1998. The current system, the INS' Non Immigrant Information System (NIIS), only captures information on the border crossings of a fraction of the foreign visitors who enter the United States each year. INS does not systematically monitor visitors during their stay.

At the outbreak of hostilities between the U.S.-led Coalition Forces and Iraq in the 1991 Persian Gulf War there were an estimated 50,000 non-immigrant visa (NIV) overstays from Iraq in the United States (this number did not include the tens of thousands of legal foreign visitors from Iraq in the U.S. at the same time). The organization responsible for knowing where these individuals were, the INS, was essentially unable to provide their whereabouts this way.

Although foreign visitors, were required to report their change of address via Form AR-11, the “Aliens Change of Address Card” under existing law and regulations and failure to submit Form AR-11 within 10 days of a change of address is punishable by fine, imprisonment and/or deportation, it took the efforts of the Federal Bureau of Investigation (FBI) to attempt to determine the location of these individuals at considerable time and expense. Similar time-consuming efforts are underway following the events of Sep. 11, 2001 and could exceed the capacity of U.S. intelligence and law enforcement.

Proposed solutions to our foreign visitors problems have been directed to entry and exit compliance of certain types of visitors. For example, the pilot program utilizing an “electronic travel card” called INSPASS can only detect when an individual enters or leaves the U.S. at an airport (not via land or sea). INSPASS is not designed for most foreign visitors—only those from Visa Waiver Pilot Program countries; other users are U.S. citizens. None of the countries on the National Security Threat List participate in the Visa Waiver Pilot Program. A further limitation of INSPASS is the very small number of users currently. INSPASS is also not user friendly in that the user must go to one of a handful of INSPASS registration offices once a year to continue their participation.

Another system, the Student and Exchange Visitor Information System (SEVIS), (formerly known as either the Student and Exchange Visitor Program SEVP or “CIPRIS”-Coordinated Inter-Agency Partnership Regulating International Students) was designed to input and update information about foreign students. The system is designed using university administrators to monitor their foreign students using SEVIS. SEVIS was designed with the belief that any likely international terrorist attack against the U.S. would come from radical members of our foreign student population. However, preliminary investigations following the events of Sep. 11, 2001 show that only one of the 19 hijackers entered the U.S. on a student visa; at least 14 of the 19 hijackers entered the U.S. on valid business or tourist visas—individuals that SEVIS is incapable of tracking.

Our recent, tragic experiences have shown that conventional means of enforcing immigration regulation, even using new technologies, are unable to address the problems caused by the vast foreign visitor population of the United States.

### OBJECTS AND SUMMARY

This disclosure presents a comprehensive solution for monitoring foreign visitors in the United States. The described techniques provide an efficient, ubiquitous and economical means of implementing existing legal mandates to track foreign visitors and provides law enforcement officials with additional tools to enforce compliance with U.S. laws and respond to crises. The monitoring system of a preferred embodiment inputs foreign visitors into a master database upon entry into the United States, interacts with law enforcement and intelligence databases to provide comprehensive screening, uses the global internet to track the visitors during their stay and registers the visitors' exit from the country. The system also provides additional opportunities to utilize the resources of ethnic communities within the United States and to influence foreign visitors—two key factors in effective law enforcement.

Accordingly, an objective of the present invention is to provide systems and methods for monitoring individuals, especially foreign visitors during their stay in a country.

Another object of the present invention is to track foreign visitors from the time the visitors enter the country until their departures.

Another object of the present invention is to capture information concerning visitors at entry and employ such information in subsequent monitoring to detect and deter visa overstays and other illegal activity.

Another object of the present invention is to implement self-reporting on the internet of foreign visitors, particularly holders of non-immigrant visas.

Another object of the present invention is to provide methods and systems for monitoring foreign visitors, which methods and systems require minimal investment in infrastructure and personnel.

Another object of the present invention is to provide methods and systems for monitoring substantially all foreign visitors thus avoiding selective monitoring on the basis of ethnic or racial profiling.

Another object of the present invention is to provide an efficient and cost effective system to meet Congress's mandate for an automated registration, monitoring and tracking system for foreign visitors of all classes, and to provide useful information to the at-risk individual visitors at the same time.

Another object of the present invention is to collect information from visitors to provide a database for monitoring foreign visitors and facilitating visa enforcement.

Another object of the present invention is to collect self-reported information from visitors over the internet using the visitors' native language.

Another object of the present invention is to implement an effective scheme for notifying sponsors of foreign visitors of visa overstays or other visa violations.

Another object of the present invention is to provide information targeted to particular reporting visitors or selected demographic groups of reporting visitors.

Another object of the present invention is to provide a means for collecting fees associated with the cost of operating the disclosed monitoring systems.

Another object of the present invention is to provide investigative enforcement mechanisms which account for various ethnic, political, economic, cultural and psychological factors involved in visa violation, international crime, and terrorism.

Another object of the present invention is to achieve intelligence penetration of insular ethnic groups associated with foreign visitors.

Another object of the present invention is to deter international terrorism by eliminating the apparent anonymity of foreign visitors and, in particular, of foreign visitors who break the law or assist those who do.

Another object of the present invention is to counter international terrorism by effectively monitoring foreign visitors and obtaining intelligence information concerning these individuals or activities whether through self-reporting or through reporting made by other visitors.

These and other objects and features will be apparent from this written description and associated drawings. These objects may be achieved by disclosed embodiments but should not be construed as limiting to the inventions as claimed.

The present invention includes methods and systems for countering international terrorism by requiring foreign visitors or users to report at one or more times and monitoring such reporting using the internet and a centralized electronic system and database. Information may be captured at the time of entry, for example by optical scanning of information currently provided by users on I-94 Arrival/Departure record forms. Such information may be stored in the database. Such a database may constitute or be used to track the timing of required reports by users. The required reports are received over the internet from users especially from remote public or private computer terminals. The identity of users who have failed to make timely reports is determined from such stored timing information and received reports.

Reporting by the user may be accomplished by logging onto a website associated with the centralized electronic system and database, and transmitting, over the internet to the centralized electronic system and database, information requested by the website. Advantageously, the information requested by the website for the report is requested in a language selected by the reporting user.

In preferred embodiments a notification is transmitted to a responsible governmental body of the identities of those users who have failed to make timely reports. In other embodiments such notification is transmitted to at least one of the user's sponsor, employer, school or other contacts. The information transmitted to the website by the user in logging in or reporting may include personal identifying information as listed on the user's authorized visa (I-94) documentation or as otherwise requested by authorities. Other requested information may include information known to the reporting foreign visitor concerning criminal activities, especially the identity of individuals or targets involved in international terrorism. At the time of reporting the website may transmit back to the reporting user information selected on the basis of information known about the reporting user such as his or her nationality, ethnic background, first language, etc. The information transmitted back may include hyperlinks selected, for example, on the basis of stored information about the reporting user.

The methods and systems of the present invention may also be used to notify the user of his or her failure to make a timely report. Such notification may be sent by e-mail and/or by mail to the last known address of the foreign visitor. Information concerning the notification may also be input into the database, including whether it was returned as non deliverable or whether a response was received from the recipient. The user may be notified by the web site of revocation of his visa, for example, for failure to make a timely report. In cases where timely reports have been made, the web site may provide an electronic receipt to the user indicating the receipt of a timely report. Such a receipt may be printed out at the user's terminal.

In other embodiments of the disclosed systems and methods include techniques for collecting user fees, for example, by requiring credit card authorization or use of a bank or telephone card to affect payment of a user fee when a report is made.

The present invention also includes a centralized data processing system for monitoring users who are required to make reports from remote terminals to a web site associated with the data processing system. The system may include data storage systems for storing data constituting or related to information gathered at entry or visa issuance. The data may include the timing of reports required by each of a plurality of users, for example derived from the visa issuance date and period for which the visa was granted. A data server provides a reporting form to users who log onto the web site and receives reports from users. A data processor identifies, from the stored data and received reports, individuals who have failed to make a timely report. The non-reporting individual may be notified of his failure to report by regular mail, electronic mail or telephone at his last known address or phone number.

The system may also include electronic data transmission capability for notifying a centralized governmental body of the identities of those individuals who have failed to make a timely report. The system may also transmit notice of visa cancellations to a centralized database accessible to local police or to a user's sponsor, employer, school, business contact, the manager of the user's place of accommodation (hotel/motel manager or landlord) or other contact of the user contained in the data base.

The foregoing is provided as a convenient summary of certain objects, aspects and features of embodiments of the present invention. However, the inventions sought to be protected are defined by the claims.

### BRIEF DESCRIPTION OF THE DRAWINGS

FIG. 1 is a schematic overview of methods and systems of preferred embodiments of the present invention.

FIG. 2 is a flow diagram indicating steps performed in methods and systems of preferred embodiments of the present invention.

FIGS. 3(a) and (b) are flow diagrams illustrating in detail examples of further steps taken in response to the occurrence of events indicated in FIG. 2.

### DETAILED DESCRIPTION

I. Data Acquisition and Monitoring

In preferred embodiments of the present invention, the entry of each visitor is registered at a border entry point into the United States. Disclosed systems and methods monitor on-going activities of all visitors to track the regulatory compliance of foreign visitors in the United States throughout their stay, to remind visitors of any non-compliance on their part, and to register their exit from the country. Where all visitors are monitored, objections based on ethnic or racial profiling are obviated. In addition, the system can be used to influence the actions and opinions of foreign visitors. The system requires a minimal investment in the infrastructure or personnel, thus reducing barriers to implementation.

As is the practice today, each visitor may be required to prepare an I-94 Arrival/Departure Record form and presents it to an INS agent at an entry point such as a border or international airport. The INS agent examines the visitor's I-94 for completeness and documents the duration of the stay. The INS agent may then take the arrival section of the I-94 and return the departure section to the visitor for return processing.

In a preferred embodiment of the present invention, the I-94 is optically scanned at the border entry point in a scanner provided for the visitor or INS agent's use, or within hours collected I-94s are optically scanned, digitized, and the information so obtained is stored in the system database. The system may store both the original image and any data that is optically recognized for further reporting, analysis, and comparison against future visitor reports. Where necessary, quality control technicians may correct missing or incorrect data. The image and associated data may be electronically sent back to the central processing station. Advantageously, the entire process is completed in less than 24 hours. If required, the original I-94s may be returned to the INS for archival purposes or retained in an environmentally controlled facility for whatever duration is required to satisfy INS policy or legal requirements.

In preferred embodiments of the present invention, the ongoing monitoring of the foreign visitors throughout their stay is largely accomplished by periodic self-reporting. Self reporting systems per se are known. The Internal Revenue Service uses self-reporting procedures with its dealings with taxpayers each year. The INS had a mandatory self-reporting process for foreign visitors as late as the 1980s. However, the INS abandoned these prior self-reporting requirements because of the difficulty in managing the associated paperwork and in detecting fraudulent reporting. Systems and methods of the present invention provide an efficient means to implement self-reporting without the burden of paperwork by using the Internet and electronic data processing to interact with the foreign visitors. To reduce fraudulent entries, in preferred embodiments, the method and system of the present invention rapidly compares the information provided by the visitor with that already on file (including the scanned I-94) to detect false entries.

Visitors may be required to log onto the system at periodic intervals during their stay, as well as at times when there is a change in address, employment, study or status. The system may provide a customizable web portal interface for the visitors that can be accessed through standard Internet access available throughout the United States, including at hotels, libraries, schools, copy centers, businesses and homes. In addition to providing a means to enter information, the web portal can be customized to provide foreign visitors with information about their location in the U.S., weather, language training or other content to make the experience a positive one for the foreign visitor.

To encourage self-reporting compliance with immigration laws and to provide information to the law enforcement and intelligence communities while avoiding the cost of unnecessary criminal investigations, the system may provide a reminder service for foreign visitors. Prior studies with respect to pre-trial release of first-time offenders and recognizance for those awaiting deportation hearings have demonstrated that reminders dramatically increase compliance. In addition, a reminder reinforces the concept that law enforcement officials are aware of the reporting deadlines and expect compliance. With the ubiquitous Internet registration solution proposed, compliance is easy once a reminder is received.

Should a visitor gain legal entry into the United States, but subsequently fail to report when required, or should the visitor provide false or inconsistent information when he does report, the system provides options for inducing the offender to correct the situation in the most efficient and cost-effective manner possible. Through additional reminders and notices, the system may involve the visitor's sponsors, school, social contacts, employers/business contacts, fellow scholars and others in obtaining compliance with visa regulations. In addition, local law enforcement officials may be notified of a real or potential problem visitor in their jurisdictions after the expiration of a grace period set by the INS. Involving social, business and educational contacts, as well as local police and others in enforcing visa regulations has an intrinsic deterrent effect on potential visa violators or international criminals. Thus, the system may be used to increase the visibility of U.S. law enforcement for the foreign visitor, without becoming onerous or overbearing.

When exiting the United States, the visitor returns the departure section of the I-94 to the airline agent during check in. A special handling process is used again for entering the visitor's I-94 departure record into the central database. The departure information may be scanned, digitized and stored as described above. Where the visitor's exit is consistent with the original terms of the visa (i.e., when he leaves the country within the time limit), the visitor's record or account in the system data base is put in a closed status. Where there are inconsistencies or failures to timely report or depart, notification can be sent to the appropriate INS office or governmental agency for action.

II. System Overview

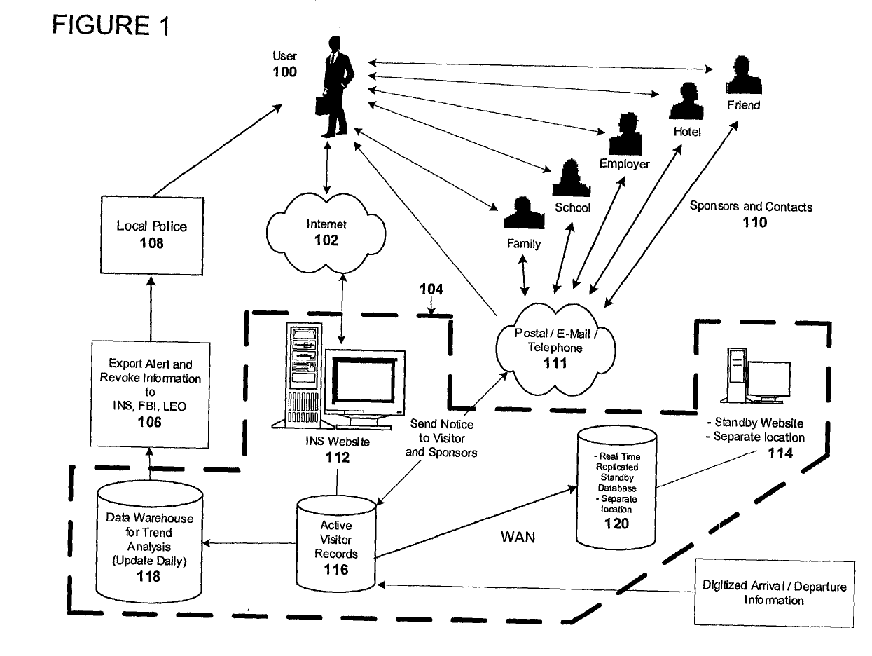

The arrangement and operation of a system and method of the preferred embodiment of the present invention will now be described in connection with FIG. 1. In the Figure, one of the potentially large number of system users is represented at 100. The user 100 may use a remote public or private computer terminal (not shown) to communicate through the Internet 102 with a data processing system 104, which may include various components and perform a variety of functions as described below. The data processing system 104 may be centralized in the sense that it appears to users as a single location or site. The data processing system 104 may also be centralized in the sense that it acts as a single collection point or repository for system data. The actual physical location of the information, servers and databases may, however, be dispersed.

A. Integration with Other Databases

The systems of the present invention may be integrated with law enforcement and intelligence databases 106. When a foreign visitor violates the terms of his visa, the system may automatically notify one or more of the following:

1. the National Crime Information Center (NCIC),

2. the local police agency with jurisdiction over the violator's last known address via the FBI's Law Enforcement On-line (LEO) for First Responders—thus providing critical, unclassified intelligence information for local police agencies 108 who exercise jurisdiction over the violator's last known address in the U.S.,

3. the FBI (and by extension the entire intelligence community),

4. the INS,

5. the national registry of authorized foreign workers (to deter illegal employment following a violation),

6. the visa violator's sponsor, family, employer/business contact, school or other contact 110 by post, e-mail or telephone as indicated at 111.

B. Technical Approach and System Architecture

The system of the present invention is an internet-based service. Non-immigrant visa holders may be required to obtain internet connectivity to register and report. The system web site (primary 112 and backup 114) may be hosted in a facility that provides the highest levels of reliability and bandwidth through a number of redundant systems, such as multiple fiber trunks to the internet provided by multiple sources, redundant power on the premises, and backup generators.

Advantageously, the system web-site is a highly scaleable and redundant web-site. Load balancing may be used to ensure that access is always available to handle requests by spreading incoming client requests among a number of servers linked together to support the application. Site capacity can be incrementally increased by simply adding servers. Active transactions or accounts handled by the System may be stored in one database 116 on a cluster of machines. Clustering provides maximum availability by allowing every machine to act in a fail-over capacity for every other machine in the cluster. Users on a failed machine may be transparently transferred to one of the machines still operating. Also the cluster provides scalability using the computing resources of all of the machines in the cluster. The system may provide secure transactions by encrypting data transmitted between the Web Browsers and the Web site using SSL (Secure Sockets Layer) technology.

A data warehouse 118 of the system may be used to store all system transactions (active and completed). This allows analysis tools and data mining services to be used for research and trend analysis. Creating different indexed views of the data allows for quick retrieval of needed information. Information from the data warehouse 118 could be securely uploaded via dedicated connections into law enforcement and INS systems 106.

A hot backup site 120 that is geographically separate from the primary site for the system may be used to insure availability in the event the primary site becomes unavailable for any reason. A secure dedicated WAN connection between the primary and backup site allows for mirroring (synchronous replication) from the primary site to the backup site.

III. Flow Charts

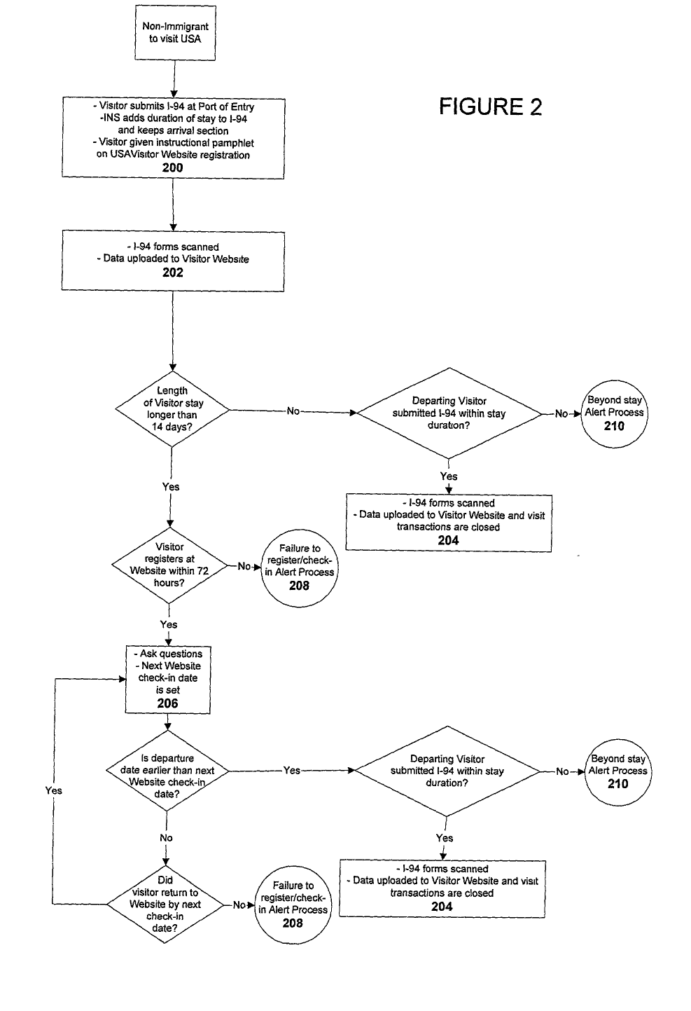

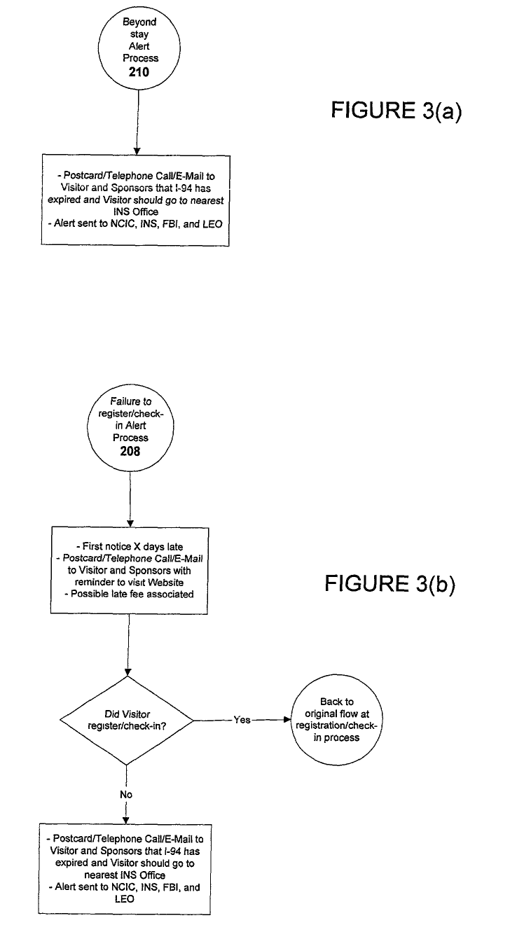

FIGS. 2 and 3 are flowcharts illustrating steps which may be performed using the system and methods of the present invention. In the flow chart a non-immigrant visa holder, user provides information at 200. In the example the information is provided as a form I-94 at the port of entry and the INS adds the duration of the stay to the form. At 202 information from the I-94 form is scanned, digitized and uploaded to the system website. Exit information is similarly obtained and uploaded at 204.

Monitoring of the user during his stay occurs at block 206 at which time information may be requested from the user, and information may be provided to the user including the next website check-in date.

The flow chart includes an example of a decision tree by which the system determines whether a failure to register, or visa overstay has occurred (208 and 210, respectively).

FIG. 3(a) illustrates further steps which may be taken in response to a determination of a visa overstay. The responses include sending a post card or e-mail notification to the user or sponsors and transmitting an alert to interested governmental agencies.

FIG. 3(b) illustrates further steps which may be taken in response to a determination that the user has failed to make an initial or subsequent report in a timely fashion. The responses are similar to the notification indicated in FIGS. 3(a). The flow chart contains the provision of returning to the flowchart of FIG. 2 once the user has rectified a failure to timely report.

IV. User Interactions with Web Site

When the user logs onto the system website from a remote public or private terminal, the user is prompted to enter personal identification information. At this time the user may select a language (typically his native language) for further interactions with the website.

In return the main server provides various information to the user including the rest of the reporting form in the requested language. The main server may also provide positive reinforcement materials and hyperlink lists selected for or by the user. The main server may also provide messages for the user from immigration authorities such as compliance reminders, notices of non-compliance with reporting requirements and targeted notices of rewards for information or capture of wanted persons. The latter may be targeted based on personal user data stored by the system.

From his terminal, the user completes the registration form. The user may also click on various hyperlinks provided. As an incentive for reporting, the system may also provide an e-mail service for the user to use for personal correspondence.

The main server logs data provided by the user and notes the date of the report in the user's account. The system may also record the identity of any individual who helps a visitor use the service. In preferred embodiments the main server provides an electronic receipt to the user's terminal which the user may print out.

The data provided by the user may be used as intelligence by governmental agencies. Data provided by various users may be correlated and data provided at different times by the same user may be checked for consistency by the data processing system.

Deterrence is the best means to fight crime and terrorism. The disclosed system is capable of providing a virtual cop-on-the-beat experience for each foreign visitor on a routine basis. The system should deter visa overstay violations.

The system's periodic, virtual cop-on-the-beat interaction with the visitors provides a means to not only deter “bad” behavior, but to encourage “good” behavior. The system website, in the same manner as a commercial web-portal, makes enormous resources available to each visitor each time he or she registers via the system. The potentially disaffected visitor will have a place to vent his frustration and a place to gather useful information for bettering his lot in the U.S., all in private.

The systems and methods of the present invention may also be used to provide a private, secure avenue for a concerned visitor to report to competent authority whether anyone has asked them to participate in criminal activity. Frequently, international organized crime syndicates prey on the perceived vulnerability of the immigrant populations in the U.S. The disclosed system can reduce the visitor's sense of vulnerability by providing a routine, virtual visit with competent legal authorities. It is a widely accepted fact that criminals prefer to deal with isolated individuals (victims) who are not in contact with a police officer. The disclosed system removes that isolation from millions of potential targets of international organized crime, and gives these former targets the means to aid the U.S. government in combating international organized crime.

The disclosed system also has the potential to augment the intelligence gathering capabilities of the U.S. Intelligence Community greatly. Existing regulations allow Department of Justice representatives to inquire as to any foreign contacts of any foreign visitor. If visitors of interest are routinely asked to identify their foreign contacts by name, address, telephone number, e-mail address, and relationship to these individuals, then the U.S. intelligence community would have access to this information as well and a basis for cross-checking such information from multiple sources.

In the event of war, or other international crisis, the disclosed system will enable the immediate monitoring of all nationals from any hostile nation who reside, or are just visiting, inside U.S. territory at the outbreak of the crisis. In this regard, the disclosed system will not only fulfill the Attorney General's mandate to register all potentially hostile individuals in a time of war, but it will provide a tool available for diplomatic use when dealing with an unfriendly foreign regime. The system will give the National Command Authority the ability to order the rapid registration of the nationals from any nation in response to events overseas.

While embodiments of the present invention have been described in the context of U.S. immigration laws and U.S. governmental agencies, it will be readily understood that the system and method can be adapted to similar use in other countries and in the service of the governmental agency of foreign nations or international law enforcement bodies.

The subject methods and systems have been described with respect to various preferred embodiments and implementations. These embodiments and implementations should be regarded as illustrative rather than restrictive. The invention sought to be protected is defined by the following claims.

I claim:

1. A method for countering international terrorism requiring Non-Immigrant Visa Holders (users) to report during their respective visits at one or more times and monitoring such reporting using the internet and an electronic system and database, comprising the steps of:
storing information from users' authorized visa documentation in the data base including information related to the timing of required reports by the users;
receiving over the internet reports from users made from remote terminals by users; and
determining from said stored timing information and received reports, the identity of individuals who have failed to make timely reports.

2. The method of claim 1, further comprising the step of transmitting notification to a responsible governmental body of the identities of individuals who have failed to make timely reports.

3. The method of claim 1, further comprising the step of transmitting notification to at least one of a user's sponsor, employer, or school that that individual has failed to make a timely report.

4. The method of claim 1, wherein the receiving of the internet reports comprises the steps of reporting users
logging onto a website associated with the electronic system and database; and
transmitting over the internet to the electronic system and database information requested by the website.

5. The method of claim 4, wherein the information requested by the website is requested in a language selected by the reporting user.

6. The method of claim 4, wherein the information requested by the website includes personal identifying information as listed on the user's authorized visa documentation.

7. The method of claim 4, further comprising the step of transmitting information to the reporting user selected on the basis of at least the nationality of the reporting user.

8. The method of claim 1, further comprising the step of notifying a non-reporting individual by e-mail of his failure to make a timely report.

9. The method of claim 1, further comprising the step of notifying a non-reporting individual by mail, electronic mail, and/or telephone, at his last known address or phone number of his failure to make a timely report.

10. The method of claim 1, further comprising the step of revoking the visas of individuals who fail to make timely reports.

11. The method of claim 1, further comprising the step of providing an electronic receipt to reporting users indicating the receipt of timely reports.

12. The method of claim 1, further comprising the step of providing hyperlinks to users making reports.

13. The method of claim 12, further comprising the step of selecting hyperlinks on the basis of stored information about the user making the report.

14. The method of claim 1, further comprising the step of transmitting over the internet to reporting users requests for information concerning criminal activities.

15. The method of claim 1, further comprising the step of comparing each reporting user's current report with at least one previous report.

16. A method of monitoring visitors from abroad comprising the steps of:
entering personal identifying information for each visitor as listed on their respective authorized visa documentation.
requiring each visitor to report at one or more times during his or her stay;
establishing a record in a central data base for each visitor including identifying information and information related to the timing of a required report;
providing a website for the visitors to log onto from remote terminals;
receiving reports from visitors including personal identifying information input at a remote terminal by each reporting visitor;
recording receipt of reports for visitors in their respective records;
determining from the records the identity of visitors who have failed to make timely reports; and
transmitting notices identifying visitors who have failed to make timely reports.

17. The method of claim 16, wherein information identifying visitors who have failed to make timely reports is stored in a database accessible to local law enforcement bodies.

18. The method of claim 16, further comprising the step of requesting information from reporting visitors concerning criminal activities and forwarding any information input to appropriate governmental authorities.

19. The method of claim 16, further comprising the step of requesting information from the visitor in a language selected by the visitor.

20. Data processing system for monitoring users who are required to make reports from remote terminals to a web site associated with the data processing system comprising:
data storage means for storing data related to the timing of reports required by each of a plurality of users;
data server means for providing a reporting form to users who log onto the web site and for receiving reports from users; and
data processing means for identifying, from the stored data and received reports, users who have failed to make a timely report.

21. The system of claim 20, further comprising means for transmitting notification to a centralized governmental body of information identifying individuals who have failed to make a timely report.

22. The system of claim 21, further comprising means for transmitting a notice of visa cancellations to a centralized data base accessible to local police.

23. The system of claim 20, further comprising means for transmitting notification to at least one of a user's sponsor, employer, or school that the user has failed to make a timely report.

24. The system of claim 20, wherein the reporting form is provided in response to receipt at the data processing system of personal identifying information from users who log onto the web site.

25. The system of claim 20, wherein the reporting form is provided to the user in a language selected by the user.

26. The system of claim 20, wherein the server means provides selected hyperlinks to users making reports.

27. The system of claim 26, wherein the server means selects hyperlinks on the basis of stored information about the user making the report.

28. The system of claim 20, wherein the reporting form contains requests for information concerning criminal activities.

29. The system of claim 20, wherein the data processing means stores reports made by each user and compares each user's current report with a previous report of that user.

30. The system of claim 20, further comprising means for providing notification by e-mail of individual's failure to make a timely report.

31. The system of claim 30, wherein the notification is provided to at least one of the following individuals: the user's sponsor, the user's employer, or the user's school.
